(19) United States
(12) Patent Application Publication
(10) Pub. No.: US 2025/0356214 A1
(43) Pub. Date: Nov. 20, 2025

(54) METHOD AND APPARATUS FOR GENERATING EQUIVALENT NEURAL NETWORKS BY DATA MANAGEMENT

(71) Applicant: EXPLAIN AI CO., LTD., TAIPEI CITY (TW)

(72) Inventors: WEN-LIANG HWANG, TAIPEI CITY (TW); SHIH-SHUO TUNG, TAIPEI CITY (TW); PIN-YU CHEN, TAIPEI CITY (TW)

(21) Appl. No.: 18/668,271

(22) Filed: May 20, 2024

(51) Int. Cl. G06N 3/0985; G06F 17/16; G06N 3/045

(52) U.S. Cl. CPC G06N 3/0985; G06F 17/16; G06N 3/045

(57) ABSTRACT

The present disclosure provides method and apparatus for generating equivalent neural network. The apparatus: training a first neural network based on a training data set; generating a second neural network by: embedding the training data set into the first neural network, and (1) removing at least one first element from the training data set to obtain a first data set and embedding the first data set into the first neural network to generate the second neural network, (2) inserting at least one second element into the training data set to obtain a second data set and embedding the second data set into the first neural network to generate the second neural network, or (3) updating the training data set by at least one third element to obtain a third data set and embedding the third data set into the first neural network to generate the second neural network.

### TECHNICAL FIELD

The present disclosure relates to a method and apparatus for generating equivalent or approximated neural networks, particularly to a method and apparatus for generating equivalent or approximated neural networks by data management.

### BACKGROUND

Neural network, one implementation of a machine learning model, is introduced for a computing device to solve complex problems like the human brain. Before being used, the neural network needs to be trained using a plurality of training data sets.

However, when different data sets are to be inserted, deleted or updated in a trained neural network, the neural network must be re-trained with the new training data set, which may be time and resource consuming. For example, regarding some opt-out policies (e.g., California Consumer Privacy Act, Colorado Consumer Protection Act, European General Data Protection Regulation, etc.), the users may re-decide the use range of the personal data they provided to the enterprise. Accordingly, the enterprise that uses the users' data for training their neural network, may need to re-train the neural network based on the re-decided use range of the personal data, and the cost could be very high.

### SUMMARY

Some embodiments of the present disclosure provide a method for generating equivalent or approximated neural networks by data management. The method includes: training a first neural network based on a training data set; receiving a deletion request, an insertion request or a modification request from a network, wherein the deletion request indicates a removal of at least one first element from the training data set (also referred to as the unlearning process), the insertion request indicates an insertion of at least one second element into the training data set, and the modification request indicates a modification of at least one third element of the training data set; generating a second neural network equivalent to or approximated to the first neural network by using the embedding technique which associates data sets to neural networks by (1) removing the at least one first element from the training data set to obtain a first data set according to the deletion request and embedding the first data set into the first neural network to generate the equivalent or approximated second neural network, (2) inserting the at least one second element into the training data set to obtain a second data set according to the insertion request and embedding the second data set into the first neural network to generate the equivalent second neural network, or (3) updating the training data set by the at least one third element to obtain a third data set according to the modification request and embedding the third data set into the first neural network to generate the equivalent or approximated second neural network.

Some embodiments of the present disclosure provide an apparatus for generating equivalent or approximated neural networks by data management. The apparatus includes a transceiver, a processor, and a storage unit. The storing unit stores a program that, when being executed, cause the processor to: train a first neural network based on a training data set; receive, via the transceiver, a deletion request, an insertion request or a modification request from a network, wherein the deletion request indicates at least one first element to be removed from the training data set, the insertion request indicates at least one second element to be added into the training data set, and the modification request indicates at least one third element of the training data set to be updated; generate a second neural network equivalent to or approximated to the first neural network by using the embedding technique which associates data sets to neural networks by (1) removing the at least one first element from the training data set to obtain a first data set according to the deletion request and embedding the first data set into the first neural network to generate the equivalent or approximated second neural network, (2) inserting the at least one second element into the training data set to obtain a second data set according to the insertion request and embedding the second data set into the first neural network to generate the equivalent second neural network, or (3) updating the training data set by the at least one third element to obtain a third data set according to the modification request and embedding the third data set into the first neural network to generate or approximated the equivalent second neural network.

The present disclosure is described in detail in the following sections. Additional features and advantages of the disclosure will be described hereinafter and form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

Aspects of the present disclosure are best understood from the following detailed description and figures. It is noted that, in accordance with the standard practice in the industry, various features are not drawn to scale. In fact, the dimensions of the various features may be arbitrarily increased or reduced for clarity of discussion.

A more complete understanding of the present disclosure may be derived by referring to the detailed description and claims when considered in connection with the Figures, where like reference numbers refer to similar elements throughout the Figures.

FIG. 1A is a block diagram of an apparatus according to some embodiments of the present disclosure.

FIGS. 1B to 1E are schematic views of generating a neural network by explicitly expressing components in the network using training data according to some embodiments of the present disclosure.

FIG. 2A is a block diagram of an apparatus according to some embodiments of the present disclosure.

FIG. 2B is a schematic view of a system according to some embodiments of the present disclosure in which a curator serves a user's demand to use their data.

FIGS. 3A to 3C are schematic views of embedding training data into weights of a neural network (i.e., training data expresses weight matrices explicitly in the neural network) according to some embodiments of the present disclosure.

FIGS. 4A to 4C are schematic views of generating an equivalent or approximated neural network after removing some training data according to some embodiments of the present disclosure.

FIGS. 5A to 5C are schematic views of generating an equivalent neural network according to some embodiments of the present disclosure, where the number of training data is selected to meet the principle of data minimization.

FIGS. 6A to 6C are schematic views of generating an equivalent neural network after inserting a data set into a neural network according to some embodiments of the present disclosure.

FIGS. 7A to 7C are schematic views of generating an equivalent neural network after modifying a training data subset in a neural network according to some embodiments of the present disclosure.

FIG. 8 is a flowchart diagram of a method according to some embodiments of the present disclosure.

FIG. 9 is a line chart to present the test accuracy versus the number of faces in training according to the method of the present disclosure.

### DETAILED DESCRIPTION

Embodiments, or examples, of the disclosure illustrated in the drawings are now described using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

It shall be understood that although the terms first, second, third, etc., may be used herein to describe various elements, components, regions, layers, or sections, these elements, components, regions, layers, or sections are not limited by these terms. Rather, these terms are merely used to distinguish one element, component, region, layer or section from another element, component, region, layer or section. Thus, a first element, component, region, layer or section discussed below could be termed a second element, component, region, layer or section without departing from the teachings of the present inventive concept.

The terminology used herein is for the purpose of describing particular example embodiments only and is not intended to be limited to the present inventive concept. As used herein, the singular forms “a,” “an” and “the” are intended to include the plural forms as well, unless the context indicates otherwise. It shall be further understood that the terms “comprises” and “comprising,” when used in this specification, point out the presence of stated features, integers, steps, operations, elements, or components but do not preclude the presence or addition of one or more other features, integers, steps, operations, elements, components, or groups thereof. As used herein, a “user” can be defined, without limitation, to include a person/subject whose electronic medical records are suitably stored and/or processed and/or configured in accordance with and operative with various embodiments as described herein.

A neural network is introduced for the computing device to solve complex problems. However, re-training neural networks is time and resource-consuming. Therefore, to realize the concept of data ownership and data access rights, there is a need to develop new methods and apparatus that can efficiently generate a neural network equivalent or approximated to an existing neural network by manipulating different data sets on the given neural network. Further, updating neural networks through managing data makes it possible to cope efficiently with the opt-out and data minimization principle in data management to retain an identified or almost identified neural network to the original neural network.

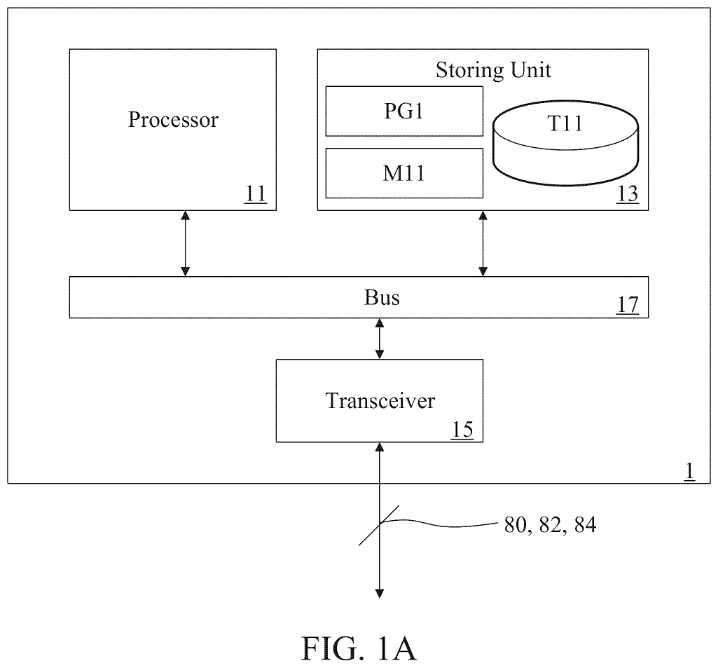

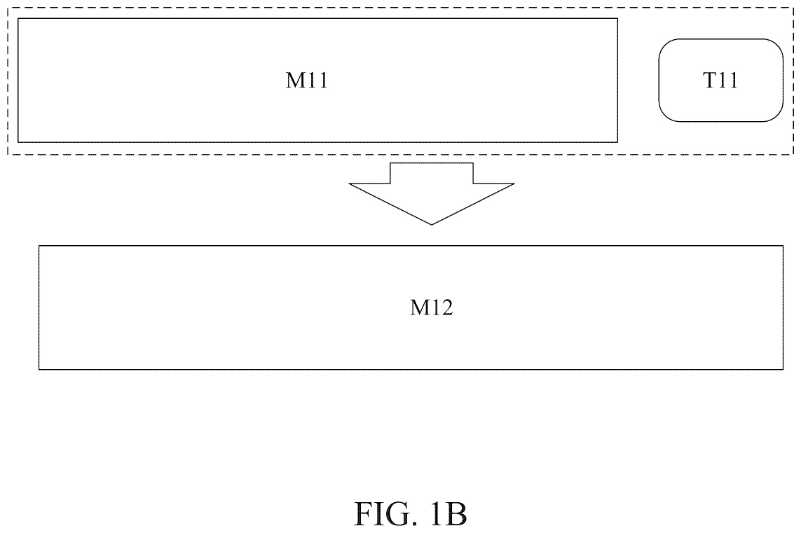

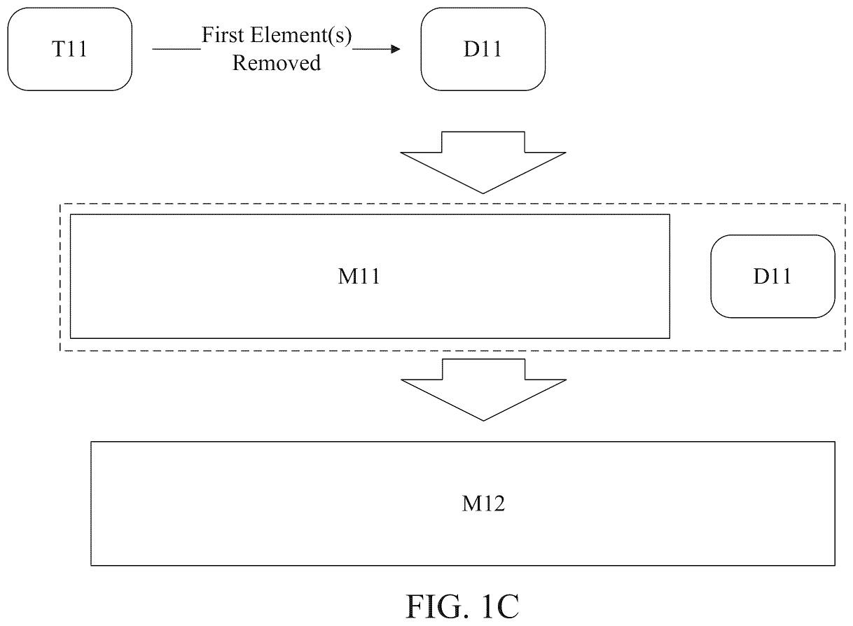

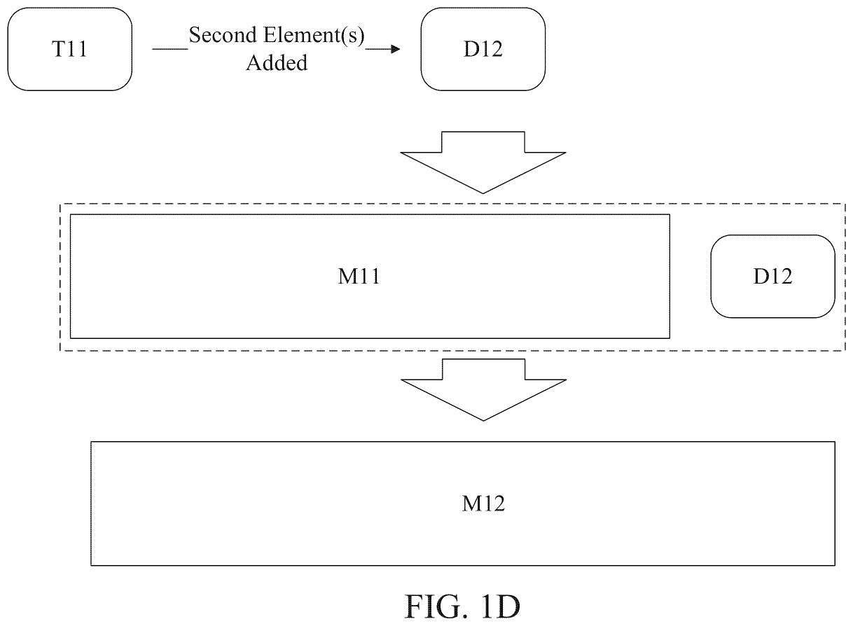

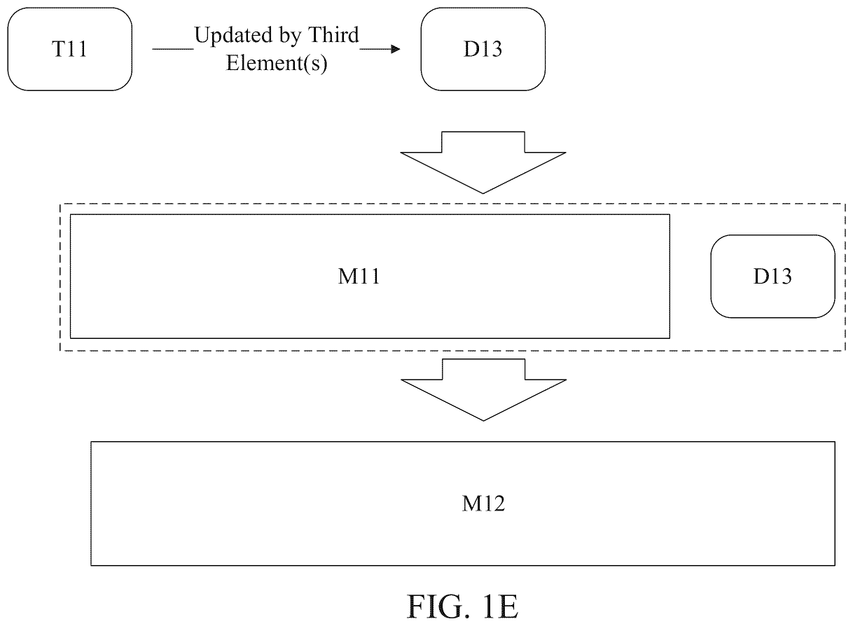

FIG. 1A illustrates a block diagram of an apparatus 1 according to some embodiments of the present disclosure. The apparatus 1 includes a processor 11, a storage unit 13, and a transceiver 15. The processor 11, the storage unit 13, and the transceiver 15 are electrically coupled through a communication bus 17.

The communication bus 17 may allow the processor 11 to execute a program PG1 stored in the storing unit 13. When executed, the program PG1 may generate one or more interrupts (e.g., software-interrupt) to cause the processor 11 to perform functions of the program PG1 for generating an equivalent or approximated neural network. Descriptions of the functions of program PG1 are provided hereinafter.

In some embodiments, the apparatus 1 generates a first neural network M11 according to a plurality of training data sets T11. After generating the first neural network M11, the apparatus 1 stores the first neural network M11 in storing unit 13 for later use. In some implementations, the training data set T11 may be collected from users or training data databases. After collection, the training data set T11 may be pre-stored, for training purposes, in the storing unit 13 (as shown in FIG. 1A) or in an external database (not shown) such as external storage or cloud database.

FIG. 1B to 1E are schematic views of generating a neural network equivalent to or approximated to first neural network M11 according to some embodiments of the present disclosure. In FIG. 1B, the apparatus 1 generates a second neural network M12 equivalent to the first neural network M11 by embedding the training data set T11 into the first neural network M11 (i.e., making the first neural network M11 as an explicit function of the training data set T11) to generate the equivalent second neural network.

The method demonstrates adaptability by:
(1) removing at least one first element from the training data set T11 to obtain a first data set D11 according to a received deletion request 80; (this flexibility is further highlighted as the first data set D11 is seamlessly embedded into the first neural network M11 to generate the equivalent or approximated second neural network M12);
(2) inserting at least one second element into the training data set T11 to obtain a second data set D12 according to a received insertion request 82 and embedding the second data set D12 into the first neural network M11 to generate the equivalent second neural network M12; or
(3) updating the training data set T11 by at least one third element to obtain a third data set D13 according to a received modification request 84 and embedding the third data set D13 into the first neural network M11 to generate the equivalent or approximated second neural network M12.

It should be noted that the method's responsiveness is a key feature, as the deletion request 80, the insertion request 82, and the modification request 84 are promptly received from a network via the transceiver 15, ensuring the system's real-time adaptability.

More specifically, although the training data T11 trains the first neural network M11, how the weights in the first neural network M11 are related to the training data set T11 is vague. Therefore, the apparatus 1 makes the relation between the weights in the first neural network M11 and training data T11 transparent (e.g., data embedment, deletion, insertion, and updating.) For example, based on some matrix calculations, the weight matrices of the first neural network M11 are expressed as a function of the training data T11. Based on the function, the apparatus 1 performs data management to generate the second neural network, M12, equivalent to or approximated to the first neural network, M11.

In some embodiments, the first neural network M11 is equivalent to the second neural network M12, which means that a first data outputted from the first neural network M11 by inputting an input data is equivalent to a second data outputted from the second neural network M12 by inputting the same input data. In other words, when the same data is respectively inputted into the first neural network M11 and the second neural network M12, the outputs will be equivalent (e.g., the same or substantially the same,) and thereof, the first neural network M11 and the second neural network M12 have the same performance.

In some embodiments, the first neural network M11 is approximated to the second neural network M12, which means that a first data outputted from the first neural network M11 by inputting an input data is approximated to a second data outputted from the second neural network M12 by inputting the same input data. In other words, when the same data is respectively inputted into the first neural network M11 and the second neural network M12, the outputs will be approximated (e.g., nearly the same,) and thereof, the first neural network M11 and the second neural network M12 have almost the same performances.

### Neural Network System

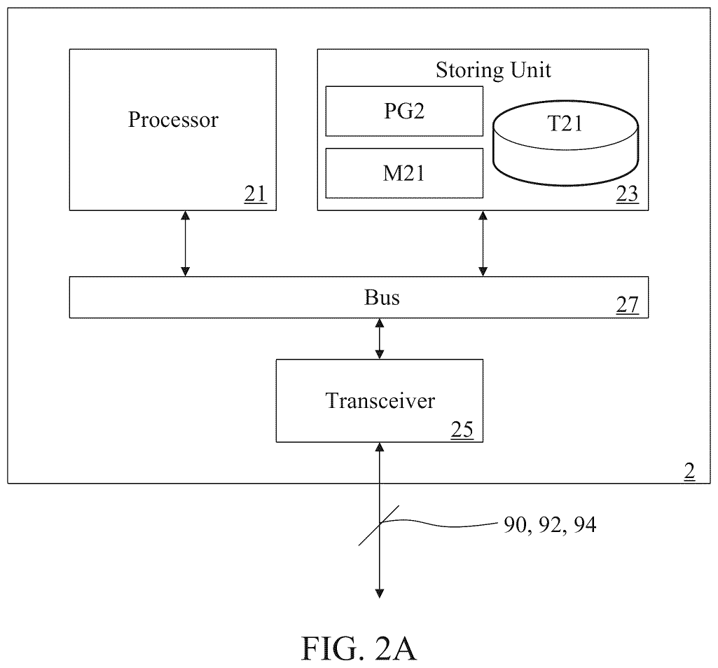

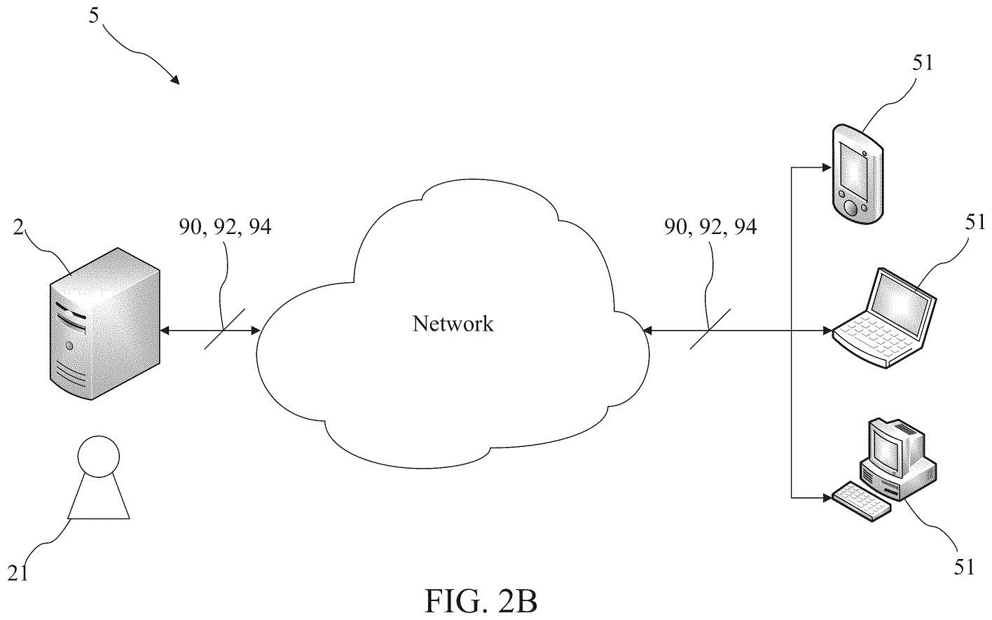

FIG. 2A illustrates a block diagram of an apparatus 2 according to some embodiments of the present disclosure. The apparatus 2 includes a processor 21, a storage unit 23, and a transceiver 25. The processor 21, the storage unit 23, and the transceiver 25 are electrically coupled through a communication bus 27.

The communication bus 27 may allow the processor 21 to execute a program PG2 in the storing unit 23. When executed, the program PG2 may generate one or more interrupts (e.g., software interrupts) to cause the processor 21 to perform functions of the program PG2 for generating an equivalent or approximated neural network. The functions of the program PG2 will be further described hereinafter.

In some embodiments, the apparatus 2 generates a first neural network M21 according to a plurality of training data sets T21. After generating the first neural network M21, the apparatus 2 stores it in storing unit 23 for later use. In some implementations, the training data sets T21 may be collected from users or databases. After collection, the training data set T21 may be pre-stored, for training purposes, in the storing unit 23 (as shown in FIG. 2A) or in an external database (not shown) such as external storage or cloud database.

People skilled in the art of neural networks should easily understand the training procedure of neural networks (e.g., the first neural network M21) based on training data sets (e.g., the training data sets T21). Therefore, the details of the neural network training procedure will not be further described.

FIG. 2B is a schematic view of a system 5 utilizing the apparatus 2 according to some embodiments of the present disclosure. In some embodiments, the system 5 may include user devices 51 (e.g., mobile phone, laptop, personal computer, etc.) and the apparatus 2. The user devices 51 may communicate with the apparatus 2 via a network. Users may control the user device 51. In particular, when the users need to change the usage of the personal data utilized by the apparatus 2, the users may use the user devices 51 to transmit a deletion request 90, an insertion request 92, or a modification request 94 to the apparatus 2 through the network. Then, after receiving the deletion request 90, the insertion request 92, or the modification request 94 from the user devices 51, a curator/operator 21 of the apparatus 2 may perform corresponding data management operations (e.g., data deletion, data insertion, or data modification) to generate a second neural network M22 equivalent to or approximated to the first neural network M21. In some embodiments, the user of the user device 51 may initiate the request, and the operator/curator of the apparatus 2 may manipulate the data management operations.

For example, the apparatus 2 of the present disclosure is an enterprise server. The apparatus 2 may utilize personal data sets provided by the user to train the first neural network, M21. When the user wants to opt out of some of the provided personal data from the apparatus 2, the user transmits the deletion request 90 via the user device 51 to the apparatus 2 through the network. The deletion request 90 demands the apparatus remove indicated personal data from the first neural network M21 by some of the data management operations described below.

### Data Embedment

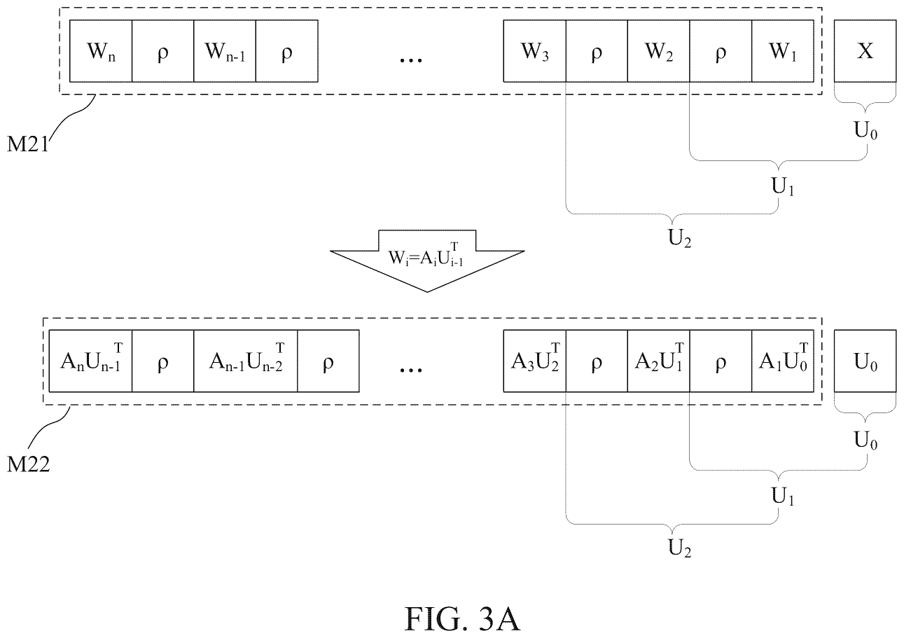

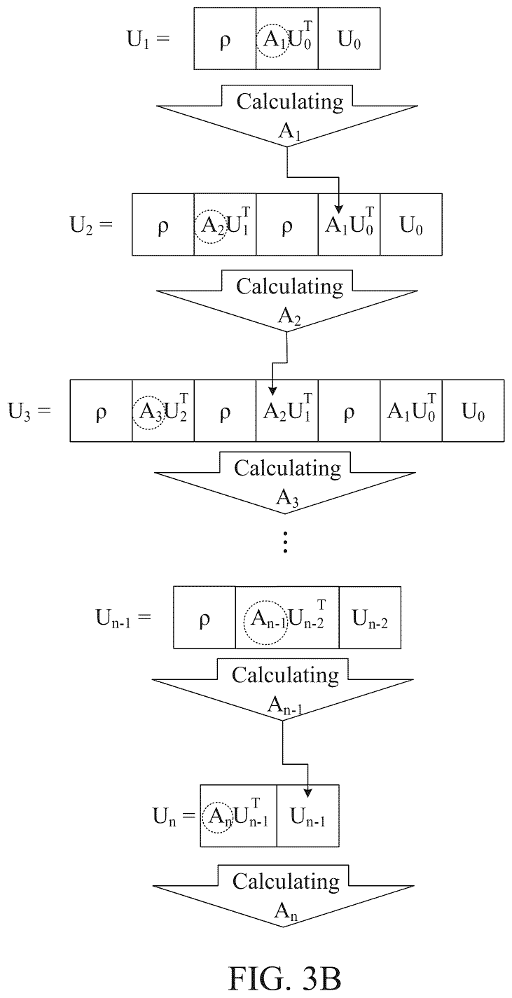

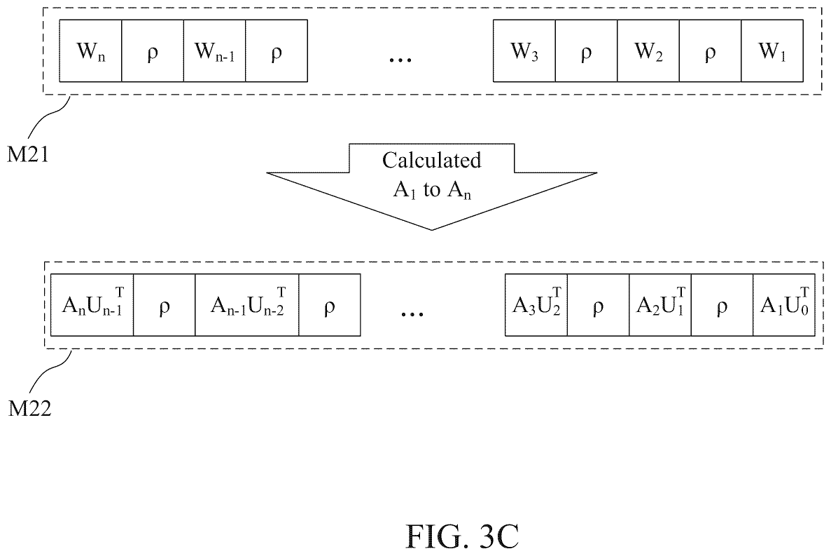

FIG. 3A to 3C are schematic views of generating equivalent or approximated neural networks by embedding the training data set T21 into the first neural network M21 according to some embodiments of the present disclosure. FIG. 3A expresses the goal of replacing weight matrices W in M21 with data-dependent matrices AU^{T} in M22, while FIGS. 3B and 3C demonstrate how to realize the goal.

In some embodiments, apparatus 2 generates a second neural network M22 by embedding the training data set T21 into the first neural network M21. The data embedment aims to express each weight matrix in the first neural network M21 as a function of the training data T21. In general, the weight matrix Wᵢ in the first neural network M21 may be expressed as

$${W}_{i} = {f}_{embed , i} ( {U}_{i - 1} ) and {U}_{i - 1} = {g}_{embed , i} ( T 21 ) ,$$

where f_{embed,i} and g_{embed,i} are functions a neural network system can execute. The training data set T21 is embedded to express all weight matrices in M21 to obtain the second neural network M22.

In particular, when the first neural network M21 is an n-layer neural network, which may be represented as:

$$M = {W}_{n} … {W}_{3} ρ {W}_{2} ρ {W}_{1} . \qquad ( 1 )$$

M is the first neural network M21. ρ is a non-linear activation function related to the neural network field. Wᵢ is a trained weight matrix of the i^{th} layer of the first neural network M21. The embedment expresses Wᵢ as

$${W}_{i} = {A}_{i} {U}_{i - 1}^{T} . \qquad ( 2 )$$

Aᵢ is a sparse matrix. Uᵢ is an input to the (i+1)^{th} layer of the first neural network M21 and an output from the i^{th} layer and, therefore, may be represented as:

$${U}_{i} = ρ {W}_{i} {U}_{i - 1} . \qquad ( 3 )$$

In these embodiments, the first neural network M21 is trained based on the training data sets T21, which means that the weight matrices W₁ to Wₙ of layers of the first neural network M21 are known parameters. Further, letting U₀=T21, according to formula (3), U₁ to Uₙ₋₁ are obtainable from the weight matrices W₁ to Wₙ₋₁, and U₀. A₁ to Aₙ in the formula (2) are unknown parameters to be calculated.

More specifically, to generate a neural network equivalent to the first neural network M21 by embedding the training data set T21, the following operations are performed:
(a) The training data set T21 is utilized as U₀, which is input X to M:

$${U}_{0} = X .$$

Therefore, according to formulas (2) and (3),

$${U}_{1} = ρ {W}_{1} X = ρ {W}_{1} {U}_{0} = ρ {A}_{1} {U}_{0}^{T} {U}_{0} .$$

Because ρ and W₁ are known parameters and U₁ is obtained from ρW₁X, A₁ is calculable,
(b) After calculating A₁, A₂ is calculable according to formulas (2) and (3),

$${U}_{2} = ρ {W}_{2} ρ {W}_{1} X = ρ {W}_{2} {U}_{1} = ρ {A}_{2} {U}_{1}^{T} {U}_{1} .$$

Because ρ, W₂ and U₁ are known parameters and U₂ is obtained from ρW₂U₁, A₂ is calculable,
(c) After calculating A₂, A₃ is calculable according to formulas (2) and (3),

$${U}_{3} = ρ {W}_{3} ρ {W}_{2} ρ {W}_{1} X = ρ {W}_{3} {U}_{2} = ρ {A}_{3} {U}_{2}^{T} {U}_{2} .$$

Because ρ, W₃ and U₂ are known parameters and U₃ is obtained from ρW₃U₂, A₃ is calculable,
(d) Repeatedly, A₄ to Aₙ are calculated.

Accordingly, the second neural network, M22, is generated and represented as

$$N = {A}_{n} {U}_{n - 1}^{T} … {A}_{3} {U}_{2}^{T} ρ {A}_{2} {U}_{1}^{T} ρ {A}_{1} {U}_{0}^{T} .$$

N is the second neural network M22. Therefore, M is equal to N, which means that the first neural network, M21, is equivalent to the second neural network, M22. In brief, the training data set T21 is introduced to M (i.e., the first neural network M21) for calculating A₁ to Aₙ in N so that N with determined A₁ to Aₙ is equivalent to M.

In some embodiments, calculating Aᵢ is based on the following formula:

$${min}_{{A}_{i}} \frac{1}{2} {‖ {W}_{i} - {A}_{i} {U}_{i - 1}^{T} ‖}^{2} + {\sum }_{j} α {‖ {A}_{i} ( j , : ) ‖}_{1} .$$

The above formula is one possible way to obtain Aᵢ. However, it does not limit the ways to obtain Aᵢ.

The above operations of data embedment may be implemented based on the below pseudo code below.

Algorithm Data embedment

Input: The n-layer neural network M= M21 trained with the training data
set T21

| | |
|---|---|
| 1: | U₀ = T21 |
| 2: | Uᵢ = ρWᵢUᵢ₋₁ for i=1, 2, ..., n-1 |
| 3: | for i=1, 2, ..., n do |
| 4: | $calculated : {min}_{{A}_{i}} \frac{1}{2} {‖ {W}_{i} - {A}_{i} {U}_{i - 1}^{T} ‖}^{2} + {\sum }_{j} α {‖ {A}_{i} ( j , : ) ‖}_{1}$ |
| 5: | end for |
| 6: | $Embed {W}_{i} = {A}_{i} {U}_{i - 1}^{T} to the neural network M 21 to obtain the neural$ |
| | network M22 |

Output: Neural network N=M22

### Data Deletion

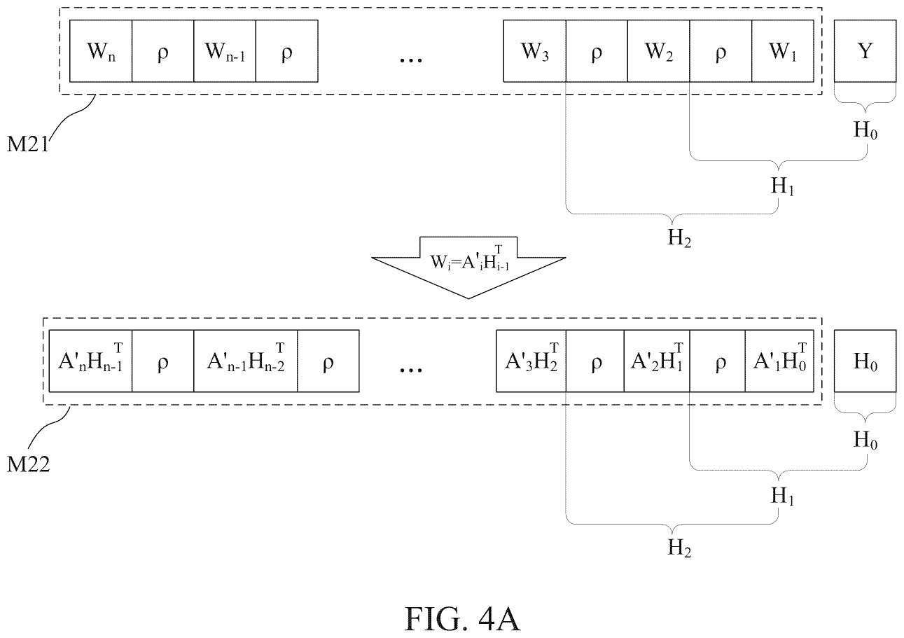

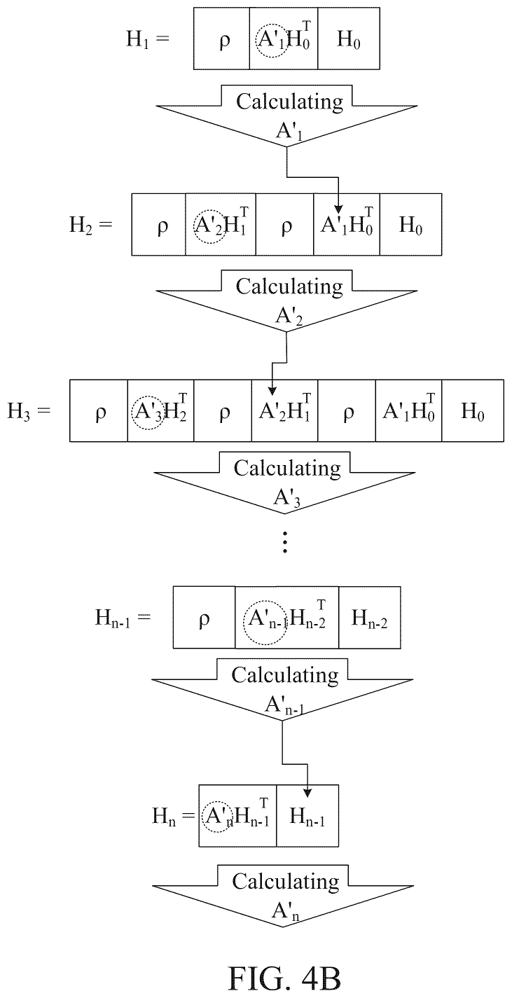

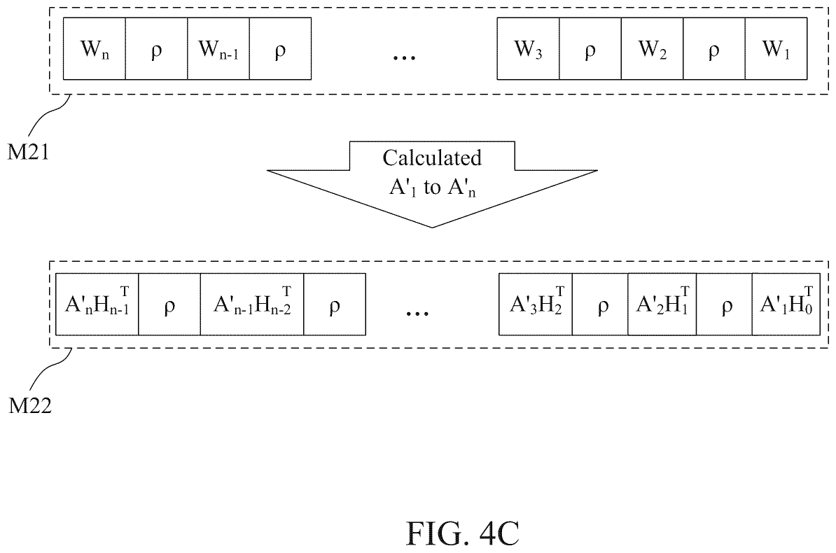

FIG. 4A to 4C are schematic views of generating an equivalent or approximated neural network by removing the data set from the first neural network M21 according to some embodiments of the present disclosure. FIG. 4A expresses the goal of replacing weight matrices Wᵢ in M21 with data-dependent matrices A′H^{T} in M22, while FIGS. 4B and 4C demonstrate how to realize the goal. In some embodiments, after receiving the deletion request 90 from the user device 51, the apparatus 2 removes at least one first element from the training data set T21 to obtain a first data set D21 according to the deletion request 90 and embeds the first data set D21 into the first neural network M21 to generate the equivalent or approximated second neural network M22.

In some embodiments, in response to the deletion request, any trained weight matrix Wᵢ in the first neural network M21 is expressed as the following functions of D21 and Hᵢ₋₁

$${W}_{i} = {f}_{embed , i} ( {H}_{i - 1} ) and {H}_{i - 1} = {g}_{embed , i} ( D 21 ) .$$

f_{embed,i} and g_{embed,i} are functions that a neural network system can execute. The first data set D21 is the dataset after removing the at least one first element from the training data set T21. The first data set D21 is embedded to obtain the second neural network M22.

More specifically, when the first neural network M21 is an n-layer neural network as formula (1). M is the first neural network M21. ρ is a non-linear activation function related to the neural network field. Wᵢ is a trained weight matrix of the i^{th} layer of the first neural network M21. In response to the deletion request, expressing Wᵢ as

$${W}_{i} = {A}_{i}^{′} {H}_{i - 1}^{T} . \qquad ( 4 )$$

A′ᵢ is a sparse matrix. Hᵢ is an input to the (i+1)^{th} layer of the first neural network M21 and an output from the i^{th} layer, and therefore may be represented as:

$${H}_{i} = ρ {W}_{i} {H}_{i - 1} . \qquad ( 5 )$$

In these embodiments, the first neural network, M21, is trained based on the training data sets T21, which means that the weight matrices W1 to Wn in layers of the first neural network, M21, are known parameters. Further, letting H₀=D21, according to formula (5), H₁ to Hₙ₋₁ are obtainable from weight matrices W₁ to Wₙ₋₁, and H₀. A′₁ to A′ₙ in the formula (4) are unknown parameters to be calculated.

More specifically, to generate a neural network equivalent or approximated to the first neural network M21 by embedding the first data set D21, the following operations are performed:
(a) The first data set D21 is set to H₀, which is input Y to M:

$${H}_{0} = Y .$$

Therefore, according to formulas (4) and (5),

$${H}_{1} = ρ {W}_{1} Y = ρ {W}_{1} {H}_{0} = ρ {A}_{1}^{′} {H}_{0}^{T} {H}_{0} .$$

Because ρ and W₁ are known parameters and H₁ is obtainable from ρW₁Y, A′₁ is calculable,
(b) After calculating A′₁, A′₂ is calculable according to formulas (4) and (5),

$${H}_{2} = ρ {W}_{2} ρ {W}_{1} Y = ρ {W}_{2} {H}_{1} = ρ {A}_{2}^{′} {H}_{1}^{T} {H}_{1} .$$

Because ρ, W₂ and H₁ are known parameters and H₂ is obtainable from ρW₂H₁, A′₂ is calculable,
(c) After calculating A′₂, A′₃ is calculable according to formulas (4) and (5),

$${H}_{3} = ρ {W}_{3} ρ {W}_{2} ρ {W}_{1} Y = ρ {W}_{3} {H}_{2} = ρ {A}_{3}^{′} {H}_{2}^{T} {H}_{2} .$$

Because ρ, W₃ and H₂ are known parameters and H₃ is obtainable from ρW₃H₂, A′₃ is calculable,
(d) Repeatedly, A′₄ to A′ₙ are calculated.

Accordingly, the second neural network, M22, is generated and represented as

$${N}^{′} = {A}_{n}^{′} {H}_{n - 1}^{T} … {A}_{3}^{′} {H}_{2}^{T} ρ {A}_{2}^{′} {H}_{1}^{T} ρ {A}_{1}^{′} {H}_{0}^{T} .$$

N′ is the second neural network M22. Therefore, M is equal to N′, which means that the first neural network M21 is equivalent to the second neural M22. In brief, the system embeds H₀ (i.e., the first data set D21) to M (i.e., the first neural network M21) to drive A′ to A′n in N, which means that H₀ is used for determining A′₁ to A′ₙ, so that N′ with determined A′₁ to A′ₙ is equivalent to M. If the removed data set is larger than the system's minimum requirement, then N approximates M. Section Data Minimization presents the approximation procedure.

In some embodiments, calculating A′ᵢ is based on the following formula:

$${min}_{{A}_{i}^{′}} \frac{1}{2} {‖ {W}_{i} - {A}_{i}^{′} {H}_{i - 1}^{T} ‖}^{2} + {\sum }_{j} α {‖ {A}_{i}^{′} ( j , : ) ‖}_{1} .$$

The above formula is one possible way to obtain A′i. However, it does not limit the ways to obtain A′ᵢ.

It should be noted that the above operations of data deletion may be implemented based on the below pseudo code below.

Algorithm Data deletion

Input: The neural network M21, trained by the training data set T21, and
the at least one first element to be removed from T21

| | |
|---|---|
| 1: | Delete the one first element from training data set T21, and the |
| | remaining data set D21 is set to H₀ |
| 2: | Hᵢ = ρWᵢHᵢ₋₁ for i=1, 2, ..., n-1 |
| 3: | for i=1, 2, ..., n do |
| 4: | $calculated : {min}_{{A}_{i}^{′}} \frac{1}{2} {‖ {W}_{i} - {A}_{i}^{′} {H}_{i - 1}^{T} ‖}^{2} + {\sum }_{j} α {‖ {A}_{i}^{′} ( j , : ) ‖}_{1}$ |
| 5: | end for |
| 6: | $Embed {W}_{i} = {A}_{i}^{′} {H}_{i - 1}^{T} to the neural network M 21 to obtain the$ |
| | neural network M22 |

Output: Neural network N'=M22

### Data Minimization

The principle of data minimization means that the apparatus 2's data controller(s) may collect only the data they need and keep it only for as long as necessary. Applying the principle means that the controller may control the minimum training data to retain the equivalent neural networks.

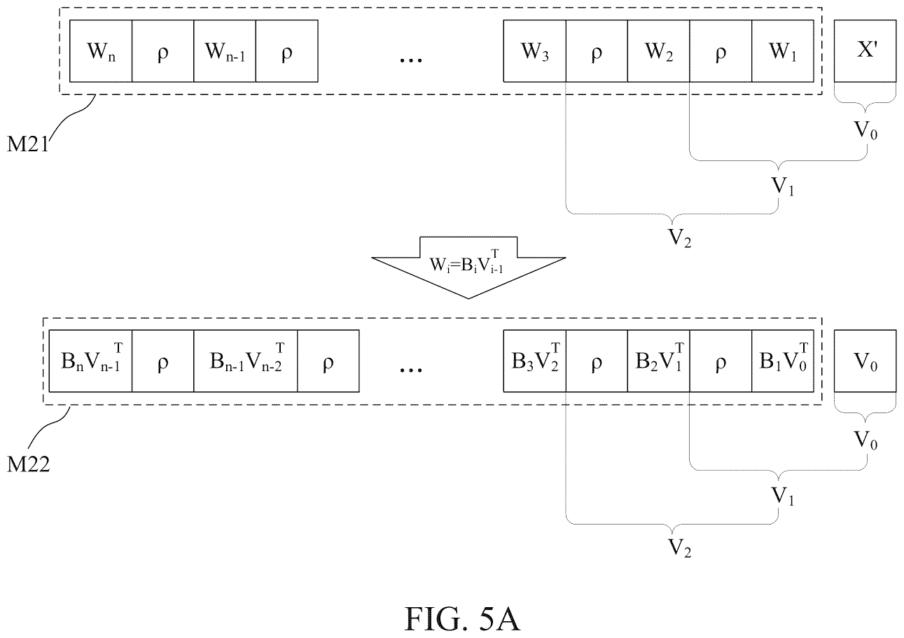

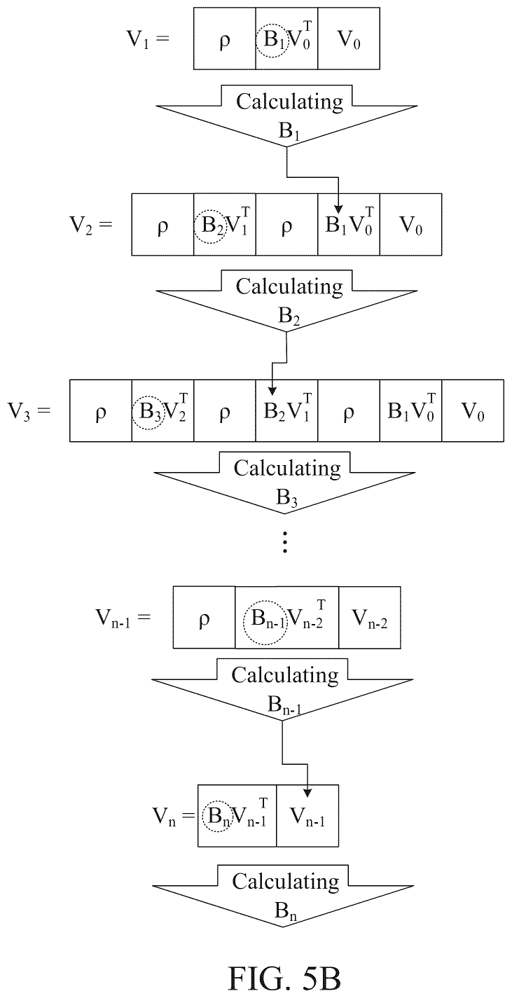

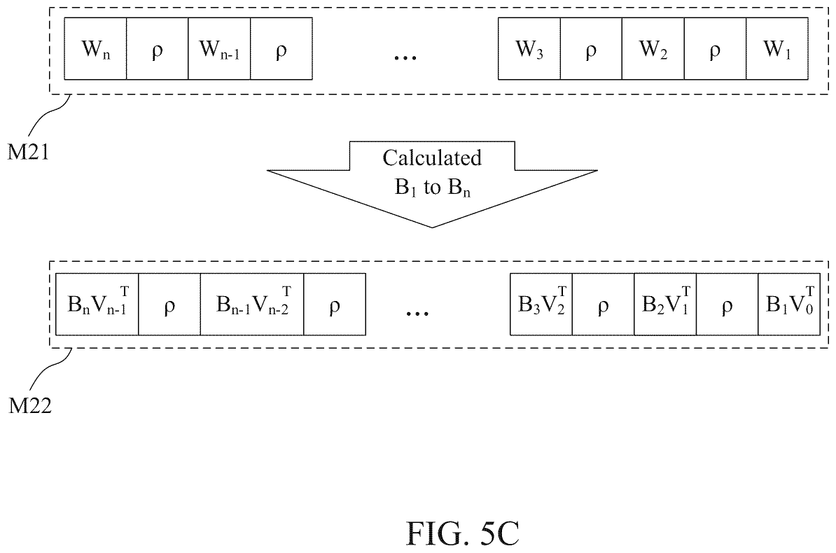

FIG. 5A to 5C are schematic views of generating equivalent neural network by embedding the minimum data set in the first neural network M21, according to some embodiments of the present disclosure. FIG. 5A expresses the goal of replacing weight matrices W in M21 with data-dependent matrices BV^{T} in M22 while FIGS. 5B and 5C demonstrate how to realize the goal.

To meet the principle of data minimization, in some embodiments, the minimum sub-data set V₀ from the training data set T21 is utilized to fulfill the following formula:

$${W}_{i} = {B}_{i} {V}_{i - 1}^{T} .$$

V₀ is the minimum sub-data set of the training data set T21, and the corresponding Bᵢ can be derived to fulfill

$${W}_{i} = {B}_{i} {V}_{i - 1}^{T}$$

for all 1. In that case, the sub-data V₀ can replace the training data set T21 embedding in the second neural network M22 to obtain an equivalent neural network that satisfies the data minimization principle. In particular, expressing Wᵢ as

$${W}_{i} = {B}_{i} {V}_{i - 1}^{T} . \qquad ( 6 )$$

Bᵢ is a sparse matrix. Vᵢ is an input to the (i+1)^{th} layer of the first neural network M21 and output from the i^{th} layer and, therefore, may be represented as:

$${V}_{i} = ρ {W}_{i} {V}_{i - 1} . \qquad ( 7 )$$

In the embodiments, V₀ is a sub-data set of the training data set T21 that has corresponding Bᵢ for all i. According to formula (7), V₁ to Vₙ₋₁ is obtainable from the weight matrices W₁ to Wₙ₋₁, and V₀. B₁ to Bₙ in the formula (6) are unknown parameters to be calculated.

More specifically, to generate a neural network equivalent to the first neural network M21 by embedding the minimum sub-data set of the training data set T21, the following operations are performed:
(a) The first data set, D21, is set to V₀, which is input X′ to M:

$${V}_{0} = {X}^{′} .$$

Therefore, according to formulas (6) and (7),

$${V}_{1} = ρ {W}_{1} {X}^{′} = ρ {W}_{1} {V}_{0} = ρ {B}_{1} {V}_{0}^{T} {V}_{0} .$$

Because ρ and W₁ are known parameters and V₁ is obtainable from ρW₁X′, B₁ is calculable,
(b) After calculating B₁, B₂ is calculable according to formulas (6) and (7),

$${V}_{2} = ρ {W}_{2} ρ {W}_{1} {X}^{′} = ρ {W}_{2} {V}_{1} = ρ {B}_{2} {V}_{1}^{T} {V}_{1} .$$

Because ρ, W₂ and V₁ are known parameters and V₂ is obtainable from ρW₂V₁, B₂ is calculable,
(c) After calculating B₂, B₃ is calculable according to formulas (6) and (7),

$${V}_{3} = ρ {W}_{3} ρ {W}_{2} ρ {W}_{1} {X}^{′} = ρ {W}_{3} {V}_{2} = ρ {B}_{3} {V}_{2}^{T} {V}_{2} .$$

Because ρ, W₃ and V₂ are known parameters and V₃ is obtainable from ρW₃V₂, B₃ is calculable,
(d) Repeatedly, B₄ to Bₙ are calculated.

Accordingly, the second neural network, M22, is generated and represented as

$${N}_{2} = {B}_{n} {V}_{n - 1}^{T} … {B}_{3} {V}_{2}^{T} ρ {B}_{2} {V}_{1}^{T} ρ {B}_{1} {V}_{0}^{T} .$$

N₂ is the second neural network M22. Therefore, M equals N₂, meaning that the first neural network, M21, is equivalent to the second neural network, M22.

In other words, after embedding the sub-data set V₀ into the first neural network M21, the second neural network M22 is equivalent to the first neural network M21. Moreover, V₀ is the minimum training data set that can be embedded into the first neural network M21 to generate the second neural network M22 equivalent to the first neural network M21.

In some embodiments, because V₁ is the smallest sub-data set of the training data set T21 that can derive the corresponding B₁ to fulfill

$${W}_{i} = {B}_{i} {V}_{i - 1}^{T}$$

for all $i$, there is no sub-data set \hat{V}ᵢ of training data set T21 smaller than Vᵢ to fulfill

$${W}_{i} = {\hat{B}}_{i} {\hat{V}}_{i - 1}^{{′}^{} T} .$$

In some embodiments, a specific sub-data set Sᵢ of the training data set T21 is smaller than Vᵢ that the corresponding Cᵢ can be found with

$${W}_{i} ≅ {C}_{i} {S}_{i - 1}^{T}$$

so that the corresponding second neural network M22 generated based on

$${C}_{i} {S}_{i - 1}^{T}$$

is an approximation to the first neural network M21.

In some embodiments, calculating Cᵢ is based on the following formula:

$${min}_{{C}_{i}} \frac{1}{2} {‖ {W}_{i} - {C}_{i} {S}_{i - 1}^{T} ‖}^{2} + {\sum }_{j} α {‖ {C}_{i} ( j , : ) ‖}_{1} .$$

The above formula is one possible way to obtain Cᵢ. However, it is not intended to limit how the Cᵢ is obtained.

In other words, after embedding the sub-data set S₀, which is smaller than the minimum sub-data set in T21, into the first neural network M21, the second neural network M22 is an approximation to the first neural network M21.

### Data Insertion

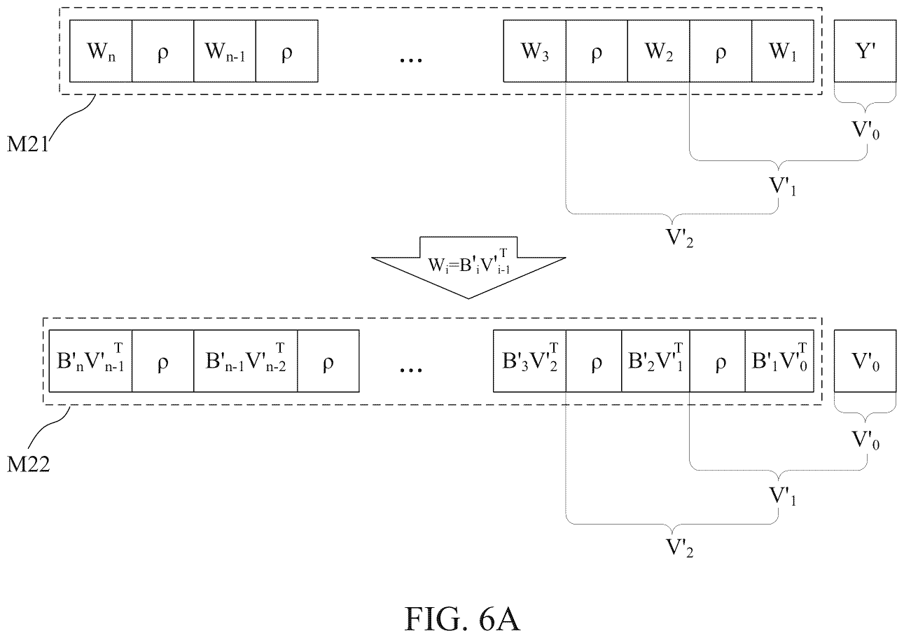

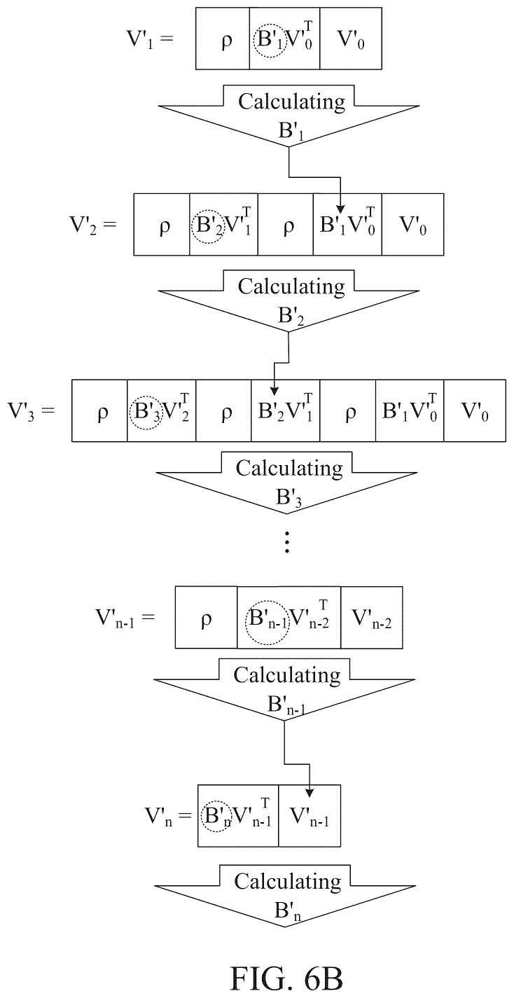

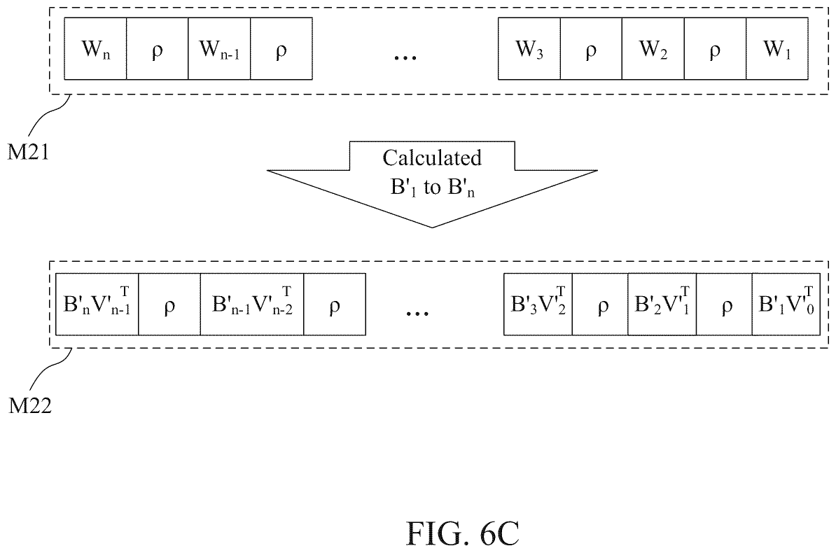

FIG. 6A to 6C are schematic views of generating an equivalent neural network by adding a data set in the first neural network M21 according to some embodiments of the present disclosure. FIG. 6A expresses the goal of replacing weight matrices W in M21 with data-dependent matrices B′V′^{T} in M22 while FIGS. 6B and 6C demonstrate how to realize the goal. In some embodiments, after receiving the insertion request 92 from the user device 51, the apparatus 2 adds at least one second element to the training data set T21 to obtain a second data set D22 according to the insertion request 92 and embeds the second data set D22 into the first neural network M21 to generate the equivalent second neural network M22.

In some embodiments, in response to the insertion request, any trained weight matrix Wᵢ in the first neural network M21 can be represented as a function of V′ᵢ₋₁

$${W}_{i} = {f}_{embed , i} ( {V}_{i - 1}^{′} ) and {V}_{i - 1}^{′} = {g}_{embed , i} ( D 22 ) .$$

f_{embed,i} and g_{embed,i} are functions that a neural network system can execute. The second data set D22 is obtained by adding the at least one second element to the training data set T21. The second data set D22 is embedded to obtain the second neural network M22.

More specifically, when the first neural network M21 is an n-layer neural network, as expressed in formula (1). M is the first neural network M21. ρ is a non-linear activation function related to the neural network field. Wᵢ is a trained weight matrix of the i^{th} layer of the first neural network M21. In response to the insertion request, expressing Wᵢ as

$${W}_{i} = {B}_{i}^{′} {V}_{i - 1}^{′ T} . \qquad ( 8 )$$

B′ᵢ is a sparse matrix. V′ᵢ is an input to the (i+1)^{th} layer of the first neural network M21 and an output from the i^{th} layer, and therefore may be represented as:

$${V}_{i}^{′} = ρ {W}_{i} {V}_{i - 1}^{′} . \qquad ( 9 )$$

In these embodiments, the first neural network M21 is trained based on the training data sets T21, which means that the weight matrices W₁ to Wₙ of layers of the first neural network M21 are known parameters. Further, letting

$${V}_{0}^{′} = D 22 ,$$

according to formula (9), V′₁ to V′ₙ₋₁ is obtainable from the weights W₁ to Wₙ₋₁, and

$${V}_{0}^{′} .$$

B′₁ to B′ₙ in the formula (8) are unknown parameters to be calculated.

More specifically, to generate a neural network equivalent to the first neural network M21 by embedding the second data set D22, the following operations are performed
(a) The second data set D22 (U₀+U″₀) (where U₀ is the training data set T21 and U″₀ is the at least one second element needed to be added into M and (U₀+U″₀) means adding data set U″₀ into data set U₀) is utilized as V′₀, which is denoted as input Y′ to M. Letting D22 be

$${V}_{0}^{′} ,$$

which is input I to M:

$${V}_{0}^{′} = {Y}^{′} .$$

Therefore, according to formulas (8) and (9),

$${V}_{1}^{′} = ρ {W}_{1} {Y}^{′} = ρ {W}_{1} {V}_{0}^{′} = ρ {B}_{1}^{′} {V}_{0}^{′ T} {V}_{0}^{′} .$$

Because ρ and W₁ are known parameters and V′₁ is obtainable from ρW₁Y′, B′₁ is calculable,
(b) After calculating B′₁, B′₂ is calculable according to formulas (8) and (9),

$${V}_{2}^{′} = ρ {W}_{2} ρ {W}_{1} {Y}^{′} = ρ {W}_{2} {V}_{1}^{′} = ρ {B}_{2}^{′} {V}_{1}^{′ T} {V}_{1}^{′} .$$

Because ρ, W₂ and V′₁ are known parameters and V′₂ is obtainable from ρW₂V′₁, B′₂ is calculable,
(c) After calculating B′₂, B′₃ is calculable according to formulas (8) and (9),

$${V}_{3}^{′} = ρ {W}_{3} ρ {W}_{2} ρ {W}_{1} {Y}^{′} = ρ {W}_{3} {V}_{2}^{′} = ρ {B}_{3}^{′} {V}_{2}^{′ T} {V}_{2}^{′} .$$

Because ρ, W₃ and V′₂ are known parameters and V′₃ is obtainable from ρW₃V′₂, B′₃ is calculable,
(d) Repeatedly, B′₄ to B′ₙ are calculated.

Accordingly, the second neural network M22 is generated and represented as:

$${N}^{″} = {B}_{n}^{′} {V}_{n - 1}^{′ T} … {B}_{3}^{′} {V}_{2}^{′ T} ρ {B}_{2}^{′} {V}_{1}^{′ T} ρ {B}_{1}^{′} {V}_{0}^{′ T} .$$

N″ is the second neural network M22. Therefore, M is equal to N″, which means that the first neural network M21 is equivalent to the second neural network M22. In brief, the system embeds V′0 (i.e., the second data set D22) in M (i.e., the first neural network M21) to derive B′₁ to B′ₙ of N″, which means that V′₀ is used for determining B′₁ to B′ₙ so that N″ with determined B′₁ to B′ₙ is equivalent to M. In some embodiments, calculating B′ᵢ is based on the following formula:

$${min}_{{B}_{i}^{′}} \frac{1}{2} {‖ {W}_{i} - {B}_{i}^{′} {V}_{i - 1}^{′ T} ‖}^{2} + {\sum }_{j} α {‖ {B}_{i}^{′} ( j , : ) ‖}_{1} .$$

The above formula is one possible way to obtain B′ᵢ. However, it does not limit the ways to obtain B′ᵢ.

The above operations of data insertion may be implemented based on the below pseudo code below.

Algorithm Data insertion
Input: The n-layer neural network M trained with the training data set
T21 , and U″₀ the at least one second element needed to be added into M

| | |
|---|---|
| 1: | Insert U″₀ the at least one second element into training data set T21 |
| | to obtain the resultant data set V'₀=D22 |
| 2: | Vᵢ = ρWᵢVᵢ₋₁ for i=1, 2, ..., n-1 |
| 3: | for i=1, 2, ..., n do |
| 4: | $calculated : {min}_{{B}_{i}^{′}} \frac{1}{2} {‖ {W}_{i} - {B}_{i}^{′} {V}_{i - 1}^{′ T} ‖}^{2} + {\sum }_{j} α {‖ {B}_{i}^{′} ( j , : ) ‖}_{1}$ |
| 5: | end for |
| 6: | $Embed {W}_{i} = {B}_{i}^{′} {V}_{i - 1}^{′ T} to the neural network M 21 to obtain the neural$ |
| | network M22 |

Output: Neural network N″=M22

### Data Modification

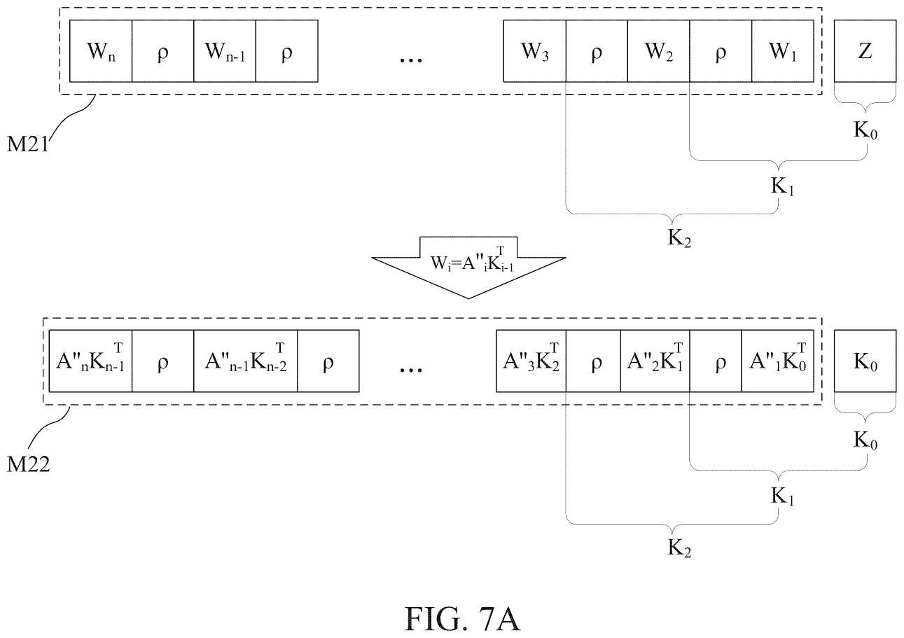

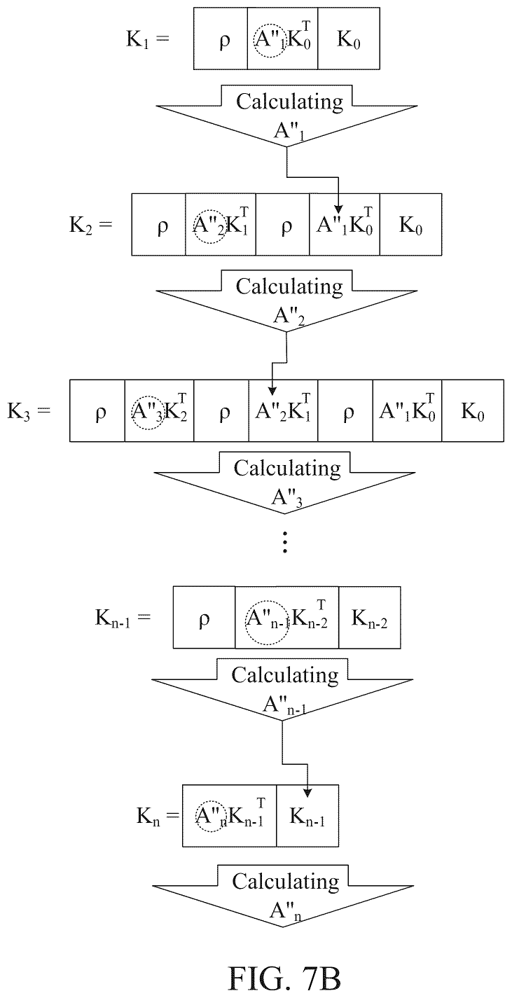

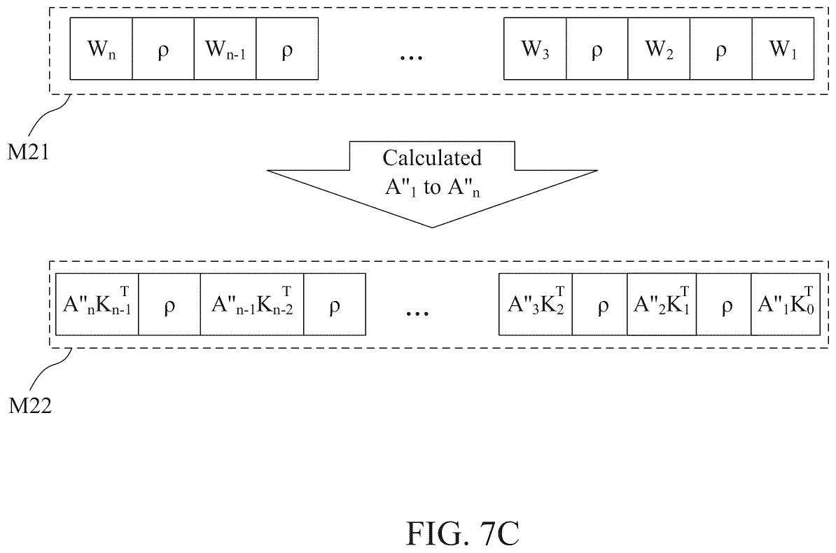

FIG. 7A to 7C are schematic views of generating an equivalent neural network by changing the data set in the first neural network M21 according to some embodiments of the present disclosure. FIG. 7A expresses the goal of replacing weight matrices W in M21 with data-dependent matrices A″K^{T} in M22 while FIGS. 7B and 7C demonstrate how to realize the goal. In some embodiments, after receiving the modification request 94 from the user device 51, the apparatus 2 updates the training data set T21 by at least third element to obtain a third data set D23 according to the modification request 92 and embeds the third data set D23 into the first neural network M21 to generate the equivalent second neural network M22. Note that the request to modify the training data set T21 may render a result insufficient for generating an identical neural network to M21. For example, if many training data sets become the same after modification, then the involved data is useless because they are the same training data. In that case, modification request 94 may be dealt with, like the data deletion, to obtain an approximation of the neural network M22 to the first neural network M21.

In some embodiments, in response to the data modification request, expressing trained weight matrix Wᵢ in the first neural network M21 as a function of Kᵢ₋₁ as follows:

$${W}_{i} = {f}_{embed , i} ( {K}_{i - 1} ) and {K}_{i - 1} = {g}_{embed , i} ( D 23 ) .$$

f_{embed,i} and g_{embed,i} are functions that a neural network system can execute. The third data set D23 is the result of modifying the training data set T21 with the at least one third element. Note that the at least on third element is a subset of training data set T21. The third data set D23 is embedded to obtain the second neural network M22.

More specifically, when the first neural network M21 is an n-layer neural network, it may be represented as the formula (1). M is the first neural network M21. ρ is a non-linear activation function related to the neural network field. Wᵢ is a trained weight of the i^{th} layer of the first neural network M21. In response to the data modification request, expressing Wᵢ as follows

$${W}_{i} = {A}_{i}^{″} {K}_{i - 1}^{T} . \qquad ( 10 )$$

A″ᵢ is a sparse matrix. Kᵢ is input to the (i+1)^{th} layer of the first neural network M21 and output from the i^{th} layer and, therefore, may be represented as:

$${K}_{i} = ρ {W}_{i} {K}_{i - 1} . \qquad ( 11 )$$

In these embodiments, the first neural network M21 is trained based on the training data sets T21, which means that the weight matrices W₁ to Wₙ of layers of the first neural network M21 are known parameters. Further, letting D23=K₀, according to formula (11), K₁ to Kₙ₋₁ is obtainable from the weight matrices W₁ to Wₙ₋₁, and K₀. A″₁ to A″ₙ in the formula (10) are unknown parameters to be calculated.

More specifically, to generate a neural network equivalent to the first neural network M21 by embedding the third data set D23, the following operations are performed:
(a) The third data set, D23, which is the training data set T21 updated by the at least one third element, is utilized as K₀, which is input Z to M:

$${K}_{0} = Z .$$

Therefore, according to formulas (10) and (11),

$${K}_{1} = ρ {W}_{1} Z = ρ {W}_{1} {K}_{0} = ρ {A}_{1}^{″} {K}_{0}^{T} {K}_{0} .$$

Because ρ and W₁ are known parameters and K₁ is obtainable from ρW₁Z, A″₁ is calculable,
(b) After calculating A″₁, A″₂ is calculable according to formulas (10) and (11),

$${K}_{2} = ρ {W}_{2} ρ {W}_{1} Z = ρ {W}_{2} {K}_{1} = ρ {A}_{2}^{″} {K}_{1}^{T} {K}_{1} .$$

Because ρ, W₂ and K₁ are known parameters and K₂ is obtainable from ρW₂K₁, A″₂ is calculable,
(c) After calculating A″₂, A″₃ is calculable according to formulas (10) and (11),

$${K}_{3} = ρ {W}_{3} ρ {W}_{2} ρ {W}_{1} Z = ρ {W}_{3} {K}_{2} = ρ {A}_{3}^{″} {K}_{2}^{T} {K}_{2} .$$

Because ρ, W₃ and K₂ are known parameters and K₃ is obtainable from ρW₃K₂, A″₃ is calculable,
(d) Repeatedly, A″₄ to A″ₙ are calculated.

Accordingly, the second neural network M22 is generated and represented as:

$${N}^{′′′} = {A}_{n}^{″} {K}_{n - 1}^{T} … {A}_{3}^{″} {K}_{2}^{T} ρ {A}_{2}^{″} {K}_{1}^{T} ρ {A}_{1}^{″} {K}_{0}^{T} .$$

N″ is the second neural network M22. Therefore, M is equal to N″, which means that the first neural network M21 is equivalent to the second neural M22. In brief, the system embeds K₀ (i.e., the third data set D23) in M (i.e., the first neural network M21) to derive A″₁ to A″ₙ of N″, which means that K₀ is used for determining A″₁ to A″ₙ so that N′″ with determined A″₁ to A″ₙ is equivalent to M.

In some embodiments, calculating A″ᵢ is based on the following formula (however, it does not limit the ways to obtain A″ᵢ):

$${min}_{{A}_{i}^{″}} \frac{1}{2} {‖ {W}_{i} - {A}_{i}^{″} {K}_{i - 1}^{T} ‖}^{2} + {\sum }_{j} α {‖ {A}_{i}^{″} ( j , : ) ‖}_{1} .$$

The above operations of data modification may be implemented based on the below pseudo code below.

Algorithm Data modification

Input: The n-layer neural network M trained with the training data T21 and
the at least one third element indicating the sub-set in T21 to be modified

| | |
|---|---|
| 1: | Update the training data set T21 with the at least one third element to |
| | obtain the resultant data set K₀=D23 |
| 2: | Kᵢ = ρWᵢKᵢ₋₁ for i=1, 2, ..., n-1 |
| 3: | for i=1, 2, ..., n do |
| 4: | $calculated : {min}_{{A}_{i}^{′′}} \frac{1}{2} {‖ {W}_{i} - {A}_{i}^{′′} {K}_{i - 1}^{T} ‖}^{2} + {\sum }_{j} α {‖ {A}_{i}^{′′} ( j , : ) ‖}_{1}$ |
| 5: | end for |
| 6: | $Embed {W}_{i} = {A}_{i}^{′′} {K}_{i - 1}^{T} to the neural network M 21 to obtain the$ |
| | neural network M2 |

Output: Neural network N''=M22

In some embodiments, updating the training data set T21 with the at least one third element may include replacing element(s) of the training data set T21 by the at least one third element.

### Illustrative Processes

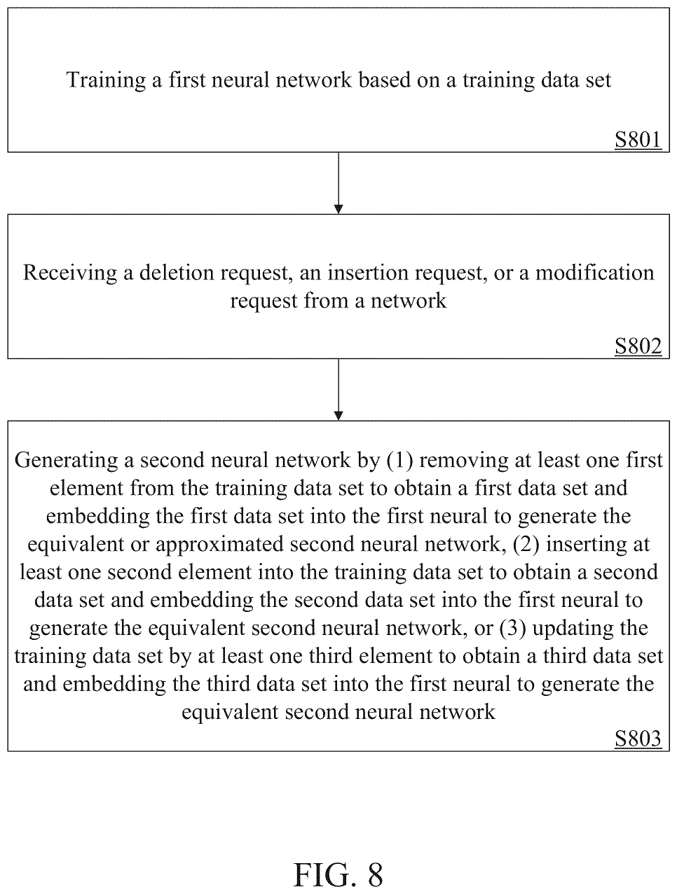

Some embodiments of the present disclosure include a method for generating an equivalent or approximated neural network by data management, and a flowchart diagram thereof is shown in FIG. 8. The method of some embodiments is for use in an apparatus (e.g., the apparatus of the aforesaid embodiments). Detailed steps of the method are described below.

Step S801 is executed, by the apparatus, to train a first neural network based on a training data set. Step S802 is executed, by the apparatus, to receive a deletion request, an insertion request, or a modification request from a network. The deletion request indicates at least one first element to be removed from the training data set. The insertion request indicates at least one second element to be added to the training data set. The modification request indicates at least one third element in the training data set to be updated.

Step S803 is executed, by the apparatus, to generate a second neural network equivalent to or approximated to the first neural network by (1) removing the at least one first element from the training data set to obtain a first data set according to the deletion request and embedding the first data set into the first neural network to generate the equivalent or approximated second neural network (the latter appears if the remaining training data set after removing the first data set is smaller than the minimum data set requirement to derive an equivalent neural network), (2) inserting the at least one second element into the training data set to obtain a second data set according to the insertion request and embedding the second data set into the first neural network to generate the equivalent second neural network, or (3) updating the training data set by the at least one third element to obtain a third data set according to the modification request and embedding the third data set into the first neural network to generate the second neural network.

### Experimental Data

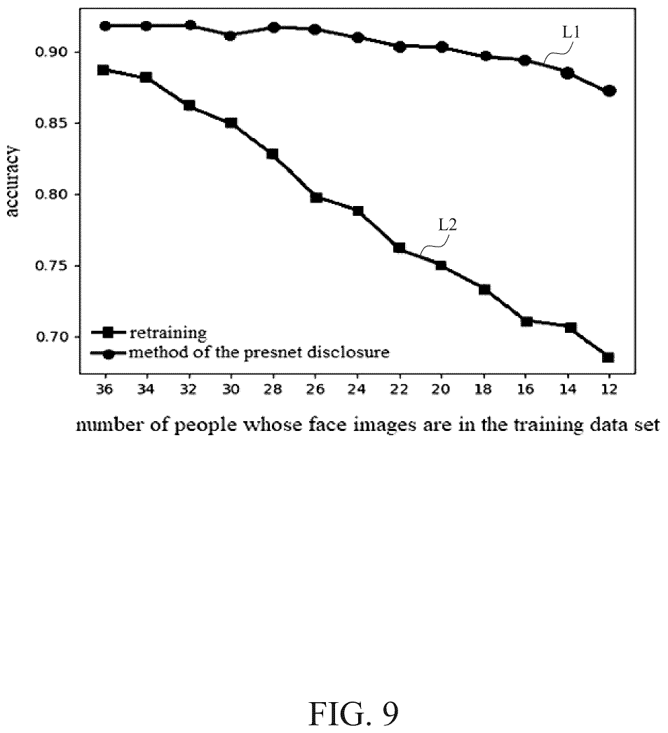

In an example experience, the data includes forty people's face images and ten face images for each person. The training dataset T21 comprises 330 photos, and the remaining 70 photos are testing images. The original neural network M21 trained by the training data T21 is to recognize whether a person wears glasses by face image(s). Each experimental turn removes two persons' face images from the training data set T21 to obtain training data set D11. For each run, we compared the results of two neural networks. One of them, M22, is according to the present disclosure's method, and the other is for benchmark comparison purposes by training a new neural network, M21, using the rest of the face images, which is now training data D11. According to FIG. 9, the test accuracy versus the number of faces in training according to the method of the present disclosure (presented by line L1) is more precise than that of the compared network (presented by line L2). Besides the accuracy, the compared process re-trained the network from scratch. In contrast, the method of the present disclosure involves only matrix operations for obtaining equivalent neural networks, which are more efficient and require much less time and resources.

It shall be appreciated that the processors mentioned in the above embodiments may be a central processing unit (CPU), other hardware circuit elements capable of executing relevant instructions, or a combination of computing circuits that are well-known by those skilled in the art based on the above disclosures.

Moreover, the storing units mentioned above may include memories, such as ROM, RAM, etc., or storage devices, such as flash memory, HDD, SSD, etc., for storing data. Further, the communication buses mentioned in the above embodiments may include a communication interface for transferring data between the elements, such as the processor, the storing unit, the sensor, and the alert element. They may include an electrical bus interface, an optical bus interface, or even a wireless bus interface. However, such a description is not intended to limit the hardware implementation embodiments of the present disclosure.

Although the present disclosure and its advantages have been described in detail, it should be understood that various changes, substitutions and alterations can be made herein without departing from the spirit and scope of the disclosure as defined by the appended claims. For example, many of the above processes can be implemented in different methodologies and replaced by other processes or a combination thereof.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include processes, machines, manufacture, and compositions of matter, means, methods, or steps within their scope.

What is claimed is:

1. A method for generating equivalent or approximated neural network by data management, comprising:
training a first neural network based on a training data set;
receiving a deletion request, an insertion request, or a modification request from a network wherein
the deletion request indicates a removal of at least one first element from the training data set,
the insertion request indicates an inclusion of at least one second element to be added into the training data set and
the modification request indicates a modification of at least one third element of the training data set;
generating a second neural network equivalent to or approximated to the first neural network by embedding the training data set into the first neural network and
removing the at least one first element from the training data set to obtain a first data set according to the deletion request and embedding the first data set into the first neural network to generate the equivalent or approximated second neural network,
inserting the at least one second element into the training data set to obtain a second data set according to the insertion request and embedding the second data set into the first neural network to generate the equivalent second neural network or
updating the training data set by the at least one third element to obtain a third data set according to the modification request and embedding the third data set into the first neural network to generate the equivalent second neural network.

2. The method of claim 1, wherein after training the first neural network by the training data set, the second neural network is equivalent to the first neural network when the first data set includes a minimum data set to be embedded into the first neural network to generate the second neural network equivalent to the first neural network.

3. The method of claim 1, wherein after training the first neural network by the training data set, the second neural network is approximated to the first neural network when the first data set is smaller than the minimum data set to be embedded into the first neural network to generate the second neural network equivalent to the first neural network.

4. The method of claim 1, wherein a first data outputted from the first neural network by inputting an input data is equivalent to or approximated to a second data outputted from the second neural network by inputting the same input data.

5. The method of claim 1, wherein trained weight matrix W in a layer in the first neural network is a multiplication of a sparse matrix A and the transpose of matrix U, where matrix U is the output of the previous layer derived by using the training data set as the input to the first neural network.

6. The method of claim 5, wherein the step of embedding the training data set into the first neural network to generate an equivalent second neural network, further includes:
calculating the sparse matrix A based on the following formula:
$${min}_{A} \frac{1}{2} {‖ W - {AU}^{T} ‖}^{2} + {\sum }_{j} α {‖ A ( j , : ) ‖}^{2} ;$$
and
generating the equivalent second neural network according to the calculated sparse matrix A.

7. The method of claim 1, wherein to respond to the deletion request, a trained weight matrix W in a layer in the first neural network is a multiplication of a sparse matrix A′ and the transpose to the matrix H, where matrix H is the output of the previous layer obtained using H₀ as inputs to the first neural network where H₀ is the second data set derived after deleting the at least one first element from the training set under the deletion request.

8. The method of claim 7, wherein the step of embedding the second data set into the first neural network to generate the equivalent second neural network, further includes:
calculating the sparse matrix A′ based on the following formula:
$${min}_{{A}^{′}} \frac{1}{2} {‖ W - {A}^{′} {H}^{T} ‖}^{2} + {\sum }_{j} α {‖ {A}^{′} ( j , : ) ‖}^{2} ;$$
and
generating the equivalent second neural network according to the calculated sparse matrix A′.

9. The method of claim 1, wherein to respond to the insertion request, a trained weight matrix W in a layer in the first neural network is a multiplication of matrix B′ and the transpose of the matrix V′ where matrix V′ is the output of the previous layer obtained using V′₀ as inputs to the first neural network where V′₀ is the second data set derived after insertion the at least one second element to the training set under the insertion request.

10. The method of claim 9, wherein the step of embedding the second data set into the first neural network to generate the equivalent second neural network, further includes:
calculating the sparse matrix B′ based on the following formula:
$${min}_{{B}^{′}} \frac{1}{2} {‖ W - {B}^{′} {V}^{′ T} ‖}^{2} + {\sum }_{j} α {‖ {B}^{′} ( j , : ) ‖}^{2} ;$$
and
generating the equivalent second neural network according to the calculated sparse matrix B′.

11. The method of claim 1, wherein to respond to the modification request, trained weight matrix W in a layer in the first neural network is a multiplication of matrix A″ and the transpose matrix of K where matrix K is the output of the previous layer obtained using K₀ as inputs to the first neural network where K₀ is the third data set derived after modifying the at least one third element in the training set under the modification request.

12. The method of claim 11, wherein the step of embedding the third data set into the first neural network to generate the second neural network, further includes:
calculating the sparse matrix A″ based on the following formula:
$${min}_{{A}^{″}} \frac{1}{2} {‖ W - {A}^{″} {K}^{T} ‖}^{2} + {\sum }_{j} α {‖ {A}^{″} ( j , : ) ‖}^{2} ;$$
and
generating the equivalent second neural network according to the calculated sparse matrix A″.

13. The method of claim 2, wherein the first data set is equal to the minimum data set, trained weight matrix W in a layer in the first neural network is a multiplication of matrix B and the transpose matrix of V where matrix V is the output of the previous layer obtained using V₀ as inputs to the first neural network where V₀ is the minimum data set.

14. The method of claim 13, wherein the step of embedding the first data set into the first neural network to generate the equivalent second neural network, further includes:
calculating the sparse matrix B based on the following formula:
$${min}_{{B}_{i}} \frac{1}{2} {‖ W - {BV}^{T} ‖}^{2} + {\sum }_{j} α {‖ B ( j , : ) ‖}^{2} ;$$
and
generating the equivalent second neural network according to the calculated sparse matrix Bᵢ.

15. The method of claim 3, wherein the first data set is smaller than the minimum data set, any trained weight matrix W in a layer in the first neural network is approximated by a multiplication of matrix C and the transpose matrix of S where matrix S is the output of the previous layer obtained using S₀ as inputs to the first neural network where S₀ is the first data set.

16. The method of claim 15, wherein the step of embedding the first data set into the first neural network to generate the equivalent second neural network, further includes:
calculating the sparse matrix C based on the following formula:
$${min}_{C} \frac{1}{2} {‖ W - {CS}^{T} ‖}^{2} + {\sum }_{j} α {‖ C ( i , : ) ‖}^{2} ;$$
and
generating the equivalent second neural network according to the calculated sparse matrix C.

17. An apparatus for generating equivalent or approximated neural network by data management, comprising:
a transceiver;
a processor electrically connected to a transceiver and
a storing unit electrically connected to the processor and including a program that, when being executed, causes the processor to:
train a first neural network based on a training data set;
receive, via the transceiver, a deletion request, an insertion request, or a modification request from a network wherein
the deletion request indicates at least one first element to be removed from the training data set,
the insertion request indicates at least one second element to be added to the training data set and
the modification request indicates at least one third element of the training data set to be updated;
generate a second neural network equivalent to or approximated to the first neural network by embedding the training data set into the first neural network and
removing the at least one first element from the training data set to obtain a first data set according to the deletion request and embedding the first data set into the first neural network to generate the equivalent or approximated second neural network,
inserting the at least one second element into the training data set to obtain a second data set according to the insertion request and embedding the second data set into the first neural network to generate the equivalent second neural network or
updating the training data set by the at least one third element to obtain a third data set according to the modification request and embedding the third data set into the first neural network to generate the equivalent second neural network.

18. The apparatus of claim 17, wherein after embedding the first data set into the first neural network, the second neural network is equivalent to the first neural network when the first data set includes a minimum data set to be embedded into the first neural network to generate the second neural network equivalent to the first neural network.

19. The apparatus of claim 17, wherein after embedding the first data set into the first neural network, the second neural network is approximated to the first neural network when the first data set is smaller than a minimum data set to be embedded into the first neural network to generate the second neural network approximate to the first neural network.

20. The apparatus of claim 17, wherein a first data outputted from the first neural network by inputting an input data is equivalent to or approximated to a second data outputted from the second neural network by inputting the same input data.
